(19) United States
(12) Patent Application Publication
(10) Pub. No.: US 2026/0362530 A1
(43) Pub. Date: Nov. 12, 2026

(54) SMF SELECTION FOR QOS DIFFERENTIATION FOR NON-3GPP DEVICES

(71) Applicant: InterDigital Patent Holdings, Inc., Wilmington, DE (US)

(72) Inventors: Anuj Sethi, Ottawa (CA); Michael Starsinic, Newtown, PA (US); Samir Ferdi, Kirkland (CA); Debashish Purkayastha, Eagleville, PA (US)

(73) Assignee: InterDigital Patent Holdings, Inc., Wilmington, DE (US)

(21) Appl. No.: 19/202,341

(22) Filed: May 8, 2025

(51) Int. Cl. H04W 76/18; H04W 48/18; H04W 76/34

(52) U.S. Cl. CPC H04W 76/18; H04W 48/18; H04W 76/34

(57) ABSTRACT

A wireless transmit/receive unit (WTRU) handles the use case wherein a SMF selected by the 5G system does not support QoS differentiation of traffic from non-3GPP devices connecting to the 5G system via the WTRU. Upon reception of a packet data unit (PDU) session modification reject message from the SMF indicating that the SMF does not support the QoS differentiation feature, the WTRU may chose a different data network name (DNN) and single network slide selection assistance information (S-NSSAI) combination to establish a new PDU session with a different SMF that supports the QoS differentiation feature.

### BACKGROUND

In the current 5G System (5GS) architecture, SMF selection happens during the PDU session establishment procedure. During the PDU session establishment procedure, it may not be known that the wireless transmit/receive unit (WTRU) will utilize the QoS differentiation feature for traffic during the PDU session. The WTRU activates the QoS differentiation feature via the PDU session modification procedure by including one or more non-3GPP device identifier(s). However, by this stage in the procedures, the SMF has already been selected. The PDU session modification procedure must take place after the PDU session establishment procedure.

Since SMF selection takes place during PDU Session Establishment, there is no guarantee that the selected SMF, which was selected before the PDU Session Modification procedure, will support the QoS differentiation of the traffic generated by the non-3GPP devices connecting to the network via the WTRU or 5G residential gateway (5G-RG).

### SUMMARY

In one embodiment, a wireless transmit/receive unit (WTRU), establishes a first packet data unit (PDU) session with a first session management function (SMF1) via an access and mobility management function (AMF) based on a first data network name (DNN) and single network slice selection assistance information (S-NSSAI) combination. The WTRU then transmits, to SMF1, a first PDU session modification request message to enable differentiated quality of service (QoS) of traffic from a non-third generation partnership project (non-3GPP) device connected to the WTRU. The WTRU then receives, from SMF1, a first PDU session modification reject message including an indication that the SMF1 does not support differentiated QoS of traffic from a non-3GPP device connected to the WTRU. Then the WTRU, in response to receiving the PDU session modification reject message, establishing a second PDU session with a second session management function (SMF2) via the AMF based on a second DNN and S-NSSAI combination.

In another embodiment, the WTRU continues by transmitting, to SMF2, a second PDU session modification request message to enable differentiated QoS of traffic from a non-3GPP device connected to the WTRU. The WTRU then receives, from SMF2, a second PDU session modification reject message including an indication that the SMF2 does not support differentiated QoS of traffic from a non-3GPP device connected to the WTRU.

In another embodiment, the WTRU continues by establishing a connection with a non-3GPP device. The WTRU then receives non-3GPP device traffic that requires uplink transmission via a PDU session.

In another embodiment, the WTRU notifies a user of the WTRU that differentiated QoS of traffic from a non-3GPP device is not supported. The WTRU then uses the second PDU session established with the SMF2 for traffic from a non-3GPP device connected to the WTRU.

In another embodiment, the WTRU notifies a user of the WTRU that differentiated QoS of traffic from a non-3GPP device is not supported. The WTRU then blocks traffic from a non-3GPP device connected to the WTRU.

In another embodiment, the WTRU transmits, to SMF2, a second PDU session modification request message to enable differentiated QoS of traffic from a non-3GPP device connected to the WTRU. Then the WTRU receives, from SM2, a PDU session modification accept message enabling differentiated QoS of traffic from a non-3GPP device connected to the WTRU. Then the WTRU uses the second PDU session with SMF2 to communicate traffic from a non-3GPP device connected to the WTRU.

In some embodiments, the PDU session modification reject message includes a 5G session management (5GSM) cause code #99.

In some embodiments, the WTRU stores a list including a plurality of DNN entries and a plurality of S-NSSAI entries.

In some embodiments, the WTRU releases the first PDU session upon receiving the first PDU session modification reject message.

In some embodiments, the first PDU session modification request message includes a non-third generation partnership project (non-3GPP) device identifier and a user plane address of a non-3GPP device.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a signal flow diagram illustrating procedures for Quality of Service (QoS) differentiation for traffic from a non-Third Generation Partnership Project (3GPP) devices connected to a 5G system via a WTRU; and

FIG. 3 is a method flow diagram of a method performed by a WTRU according to one embodiment.

### DETAILED DESCRIPTION

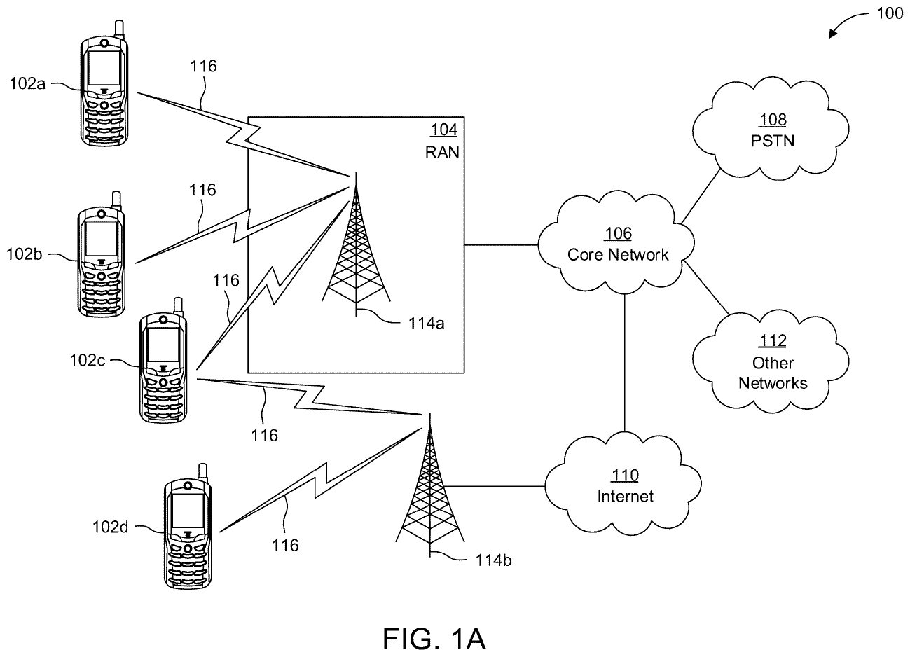

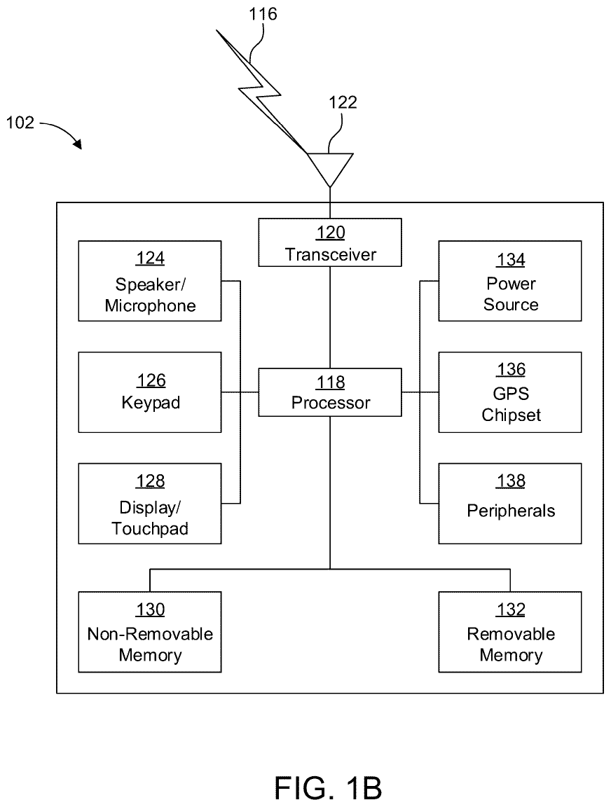

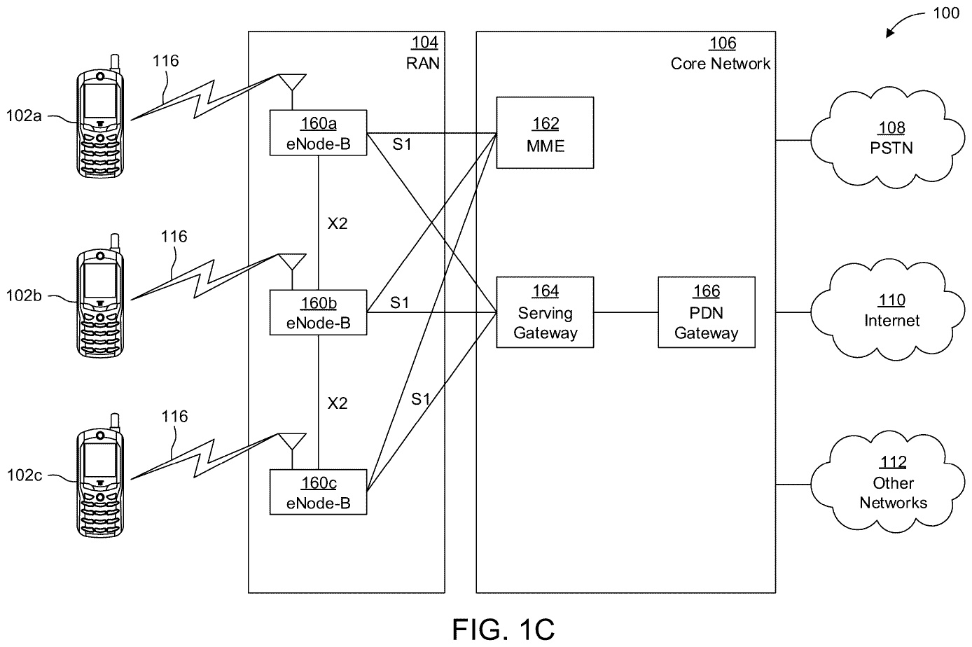

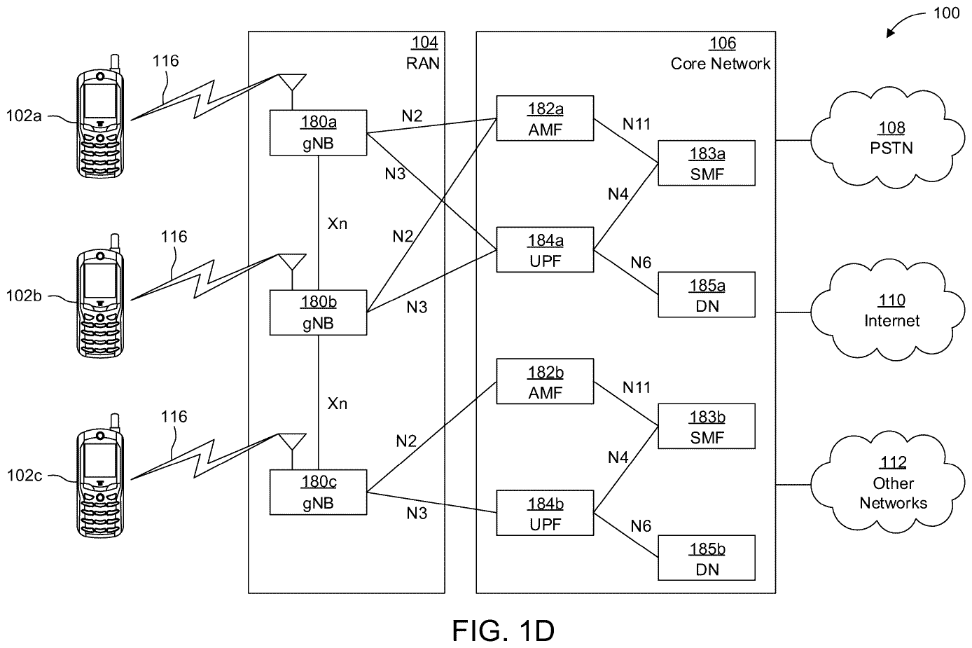

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-Third Generation Partnership Project (3GPP) access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Additionally, as used herein, a subscription permanent identifier (SUPI) is a subscription identifier. As used herein, a User Identifier may be referred to as a UID, and User Identity Profile (UIP) may be associated with a UID which is linked with a 5GS subscriber/subscription information and contains information specific to the user identifier (e.g. user identifier, associated devices, QoS information, linked subscription identified by SUPI, UID specific network resources and configuration (for example, slices, RAT restrictions, aggregate maximum bitrate (AMBR), closed access group (CAG) information, steering of roaming (UID specific prioritized VPLMN selection information), subscribed data network name (DNN) list, default DNN, etc.) The UIP could be either stored within the 5GS (e.g. UDR) or could be stored by a third party server/credential holder.

The terms wireless transmit/receive unit (WTRU), user equipment (UE), and 5G residential gateway (5G-RG) are interchangeable. In some embodiments, a 5G-RG is a type of UE or WTRU.

Recent developments in 5G standardization efforts, particularly within the 3rd Generation Partnership Project (3GPP), have focused on enhancing the 5G system architecture to enable the creation and utilization of user-specific identifiers. These enhancements are intended to improve user experience, optimize network performance, and extend service capabilities to both human users and non-3GPP devices. One key objective is to allow network settings and service provisions to be tailored to the specific needs of individual users or devices, beyond what is currently possible using only subscription-based identifiers.

In this context, a “user” may refer not only to a human user of a WTRU, but also to a non-3GPP device that communicates with the 5G system via a gateway WTRU or 5G Residential Gateway(5G-RG). This shift in focus necessitates the ability to distinguish and manage such devices individually, particularly those located behind a gateway-type device (WTRU or 5G-RG, for example).

A central technical challenge arises from scenarios in which non-3GPP devices access the 5G core (5GC) network through a WTRU or 5G-RG. Recent studies address how the 5GC can identify these individual non-3GPP devices and implement appropriate policy controls for their traffic. One objective is to support identification and policy control without requiring each non-3GPP device to establish an independent NAS (Non-Access Stratum) context or support 5G authentication procedures.

Other objectives include enabling the 5GC to identify individual non-3GPP devices behind a UE or 5G-RG, for purposes such as differentiated billing or service provisioning, as well as to enable the network to apply traffic-specific policy control, including quality of service (QoS) differentiation, for distinct non-3GPP devices sharing a single subscription connection via a WTRU or 5G-RG, as well as to enable operators to impose limits on the number of simultaneously active user identifiers associated with a single UE or 5G-RG.

It is noted that the “user identifiers” in this context refer to identifiers associated with individual non-3GPP devices behind a gateway-type WTRU or 5G-RG. Importantly, the objectives are intended to met without modifications to Layer 1 or Layer 2 protocols of the non-3GPP devices, nor is support for 5G-Authentication and Key Agreement (AKA) authentication or individual NAS sessions per device desired. Interoperability and compatibility considerations are also relevant. For instance, solutions designed for Ethernet PDU sessions must remain functional in the presence of randomized MAC addresses.

As noted above, QoS differentiation of traffic for non-3GPP devices connecting via a WTRU or a 5G-RG may be desired. A 5GS can support QoS differentiation of traffic for non-3GPP devices connecting through the WTRU, (for example, as specified in 3GPP TS 23.501). The WTRU and network may support QoS differentiation of traffic for non- 3GPP devices.

When a non-3GPP device is connecting to the network via a WTRU, the WTRU can bind the non-3GPP device identifier to a non-3GPP device for the traffic of non-3GPP device that requires differentiated QoS. This binding enables the 5GS to distinguish between the traffic generated by different non-3GPP devices connected through the same WTRU. It is noted, for completeness, that QoS differentiation of traffic for non-3GPP device identifiers also applies to the wireline access when a non-3GPP device is connecting to the 5G-RG.

The WTRU enables QoS differentiation of traffic from one or more non-3GPP device associated with a non-3GPP device identifier by providing the non-3GPP device identifier and the corresponding connection information to the SMF in a PDU session modification procedure. The WTRU provides the non-3GPP device connection information for the non-3GPP device depending on the PDU session type of the PDU session. For Ethernet PDU session type, the WTRU may include the non-3GPP device identifier and ethernet connection information. For IPv4 PDU session type, the WTRU may include the non-3GPP device identifier and IPv4 connection information. For IPv6 PDU session type, the WTRU may include the non-3GPP device identifier and IPv6 connection information. For IPv4IPv6 PDU session type, the WTRU may include the non-3GPP device identifier and IPv4 connection information, IPv6 connection information, or a combination of IPv4 connection information and IPv6 connection information.

Shortcomings of the existing design may include one or more of the following issues. During the PDU session establishment procedure, the WTRU cannot indicate that the WTRU would like to use the PDU session for QoS differentiation of traffic associated with a non-3GPP device. The WTRU may include the N3GPPP-ID (Non-3GPP device identifier) in the PDU session modification procedure, after a PDU session has been established, to activate the QoS differentiation feature. Since the SMF is selected during the PDU session establishment procedure, when activating the QoS differentiation feature during the PDU session modification procedure, the 5GS system cannot guarantee that the chosen SMF supports the QoS differentiation for the non-3GPP devices connecting via the WTRU.

The embodiments described herein enable a WTRU (or 5G-RG) to handle the scenario where the SMF selected by the 5GC at PDU session establishment does not support a later request for QoS differentiation of traffic for a non-3GPP device connecting via the WTRU. Upon reception of a reject message from an SMF indicating that the SMF does not support the QoS differentiation feature, the WTRU may perform multiple actions, including, for example, choose a different DNN and single network slide selection assistance information (S-NSSAI) combination from a configured parameter list which might result in selection of a different SMF which supports the QoS differentiation feature, and/or the WTRU may indicate the to the user of the WTRU that the QoS differentiation feature is not available, and/or send the traffic from the non-3GPP device(s) to a default QoS flow, and/or block the traffic from the connected non-3GPP device(s).

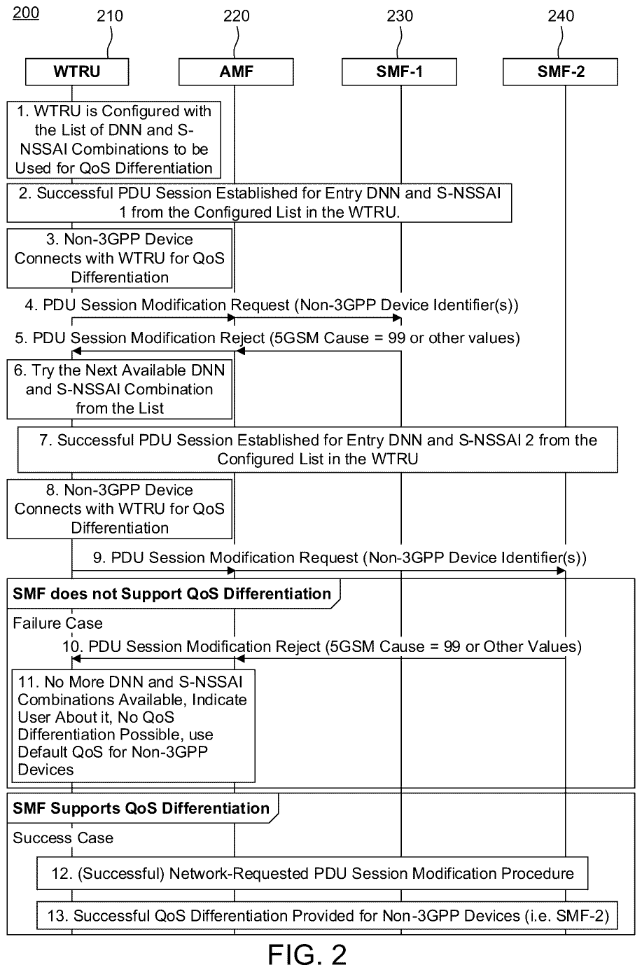

In one embodiment, the WTRU is configured to handle a scenario where an SMF does not support QoS differentiation of traffic for non-3GPP devices. FIG. 2 illustrates a call flow of an example procedure where the WTRU establishes a PDU session and attempts to activate the QoS differentiation of the traffic from a non-3GPP device feature. In this example embodiment, the SMF associated with the established PDU does not support the feature. It is noted that the WTRU in the procedure of FIG. 2 may be a 5G-RG.

In step 1, the WTRU 210 is configured with parameter values of DNN information and S-NSSAI information, forming a DNN and S-NSSAI combination that may be used for QoS differentiation of traffic from one or more non-3GPP devices connecting via the WTRU. This DNN and S-NSSAI combination may be stored by the WTRU 210 in a memory in the form of a DNN/S-NSSAI list.

In step 2, the WTRU 210 selects a first entry of DNN and S-NSSAI information, or picks a random entry, from the stored DNN/S-NSSAI list. For example, the WTRU 210 may select DNN/S-NSSAI-1 from the stored parameter information configured for the QoS differentiation of the traffic for non-3GPP devices connecting via the WTRU. WTRU 210 successfully establishes a PDU session with the core network. The AMF 220 selects SMF-1 230 during the PDU session establishment procedure. AMF 220 is not aware that the WTRU 210 intends to use the QoS differentiation feature because, as described above, this information is not included in the PDU session establishment procedure. AMF 220 is also likely unaware of whether the selected SMF (i.e. SMF-1 230) supports this feature or not.

The WTRU 210 may determine to establish the PDU session because it determines that traffic needs to be transmitted in the uplink. The traffic which causes this determination by the WTRU 210 may or may not have originated from a non-3GPP device. The traffic may have originated from an application that is hosted in the terminal equipment part of the WTRU 210. The traffic may have originated from a non-3GPP device that is connected to the WTRU 210 via a wireless protocol (such as Wi-Fi, for example).

In some embodiment, the WTRU 210 may be configured to establish the PDU session during a power up procedure. In other embodiments, the WTRU 210 may be configured to establish the PDU session when a user activates the QoS differentiation of the traffic for non-3GPP devices connecting via the WTRU feature. For example, when a user uses a graphical user interface (GUI) to indicate that the traffic of one or more non-3GPP devices that are connected to the WTRU requires QoS differentiation.

In step 3, one or more non-3GPP device(s) (not shown) connect to the WTRU 210 and the one or more non-3GPP device(s) generate traffic that needs to be sent in the uplink. Note that this step may take place before step 2 or after it, as shown in FIG. 2. In other words, the PDU session establishment may occur before or after the WTRU 210 receives information from one or more non-3GPP devices to be sent in the uplink.

In step 4, the WTRU 210 triggers the PDU session modification procedure to enable the QoS differentiation of the traffic from the connected non-3GPP device(s) connected to the WTRU 210. The WTRU 210 sends a PDU Session Modification Request Message to the SMF-1 230 via the AMF 220. The PDU Session Modification Request Message includes the non-3GPP device identifier(s) associated with the one or more non-3GPP devices connected to the WTRU 210. Additionally or alternatively, the WTRU 210 may also include the user plane address information of each non-3GPP device.

In step 5, since in this scenario the selected SMF-1 230 does not support the QoS differentiation of the traffic for non-3GPP devices connecting via the WTRU feature, SMF-1 230 rejects the PDU session modification request and sends a PDU session modification reject message to the WTRU 210. The PDU session modification reject message may include an information element that indicates a 5G session management (5GSM) cause code #99. This cause code indicates that “Information element non-existent or not implemented”. This 5GSM cause code indicates that the equipment sending this cause has received a message which includes information elements not recognized because the information element identifier is not defined or it is defined but not implemented by the equipment sending the 5GSM cause. However, the information element is not required to be present in the message in order for the equipment sending the 5GSM cause to process the message.

On reception of the PDU session modification reject message, the WTRU 210 could either release the PDU session if it's not being used for other traffic, or if the PDU session is being used or will be used for other traffic, the PDU session is not released. Reception of the PDU session modification reject message with the cause code #99 may trigger the WTRU 210 to send a PDU session release request to the SMF-1 230 to release the PDU Session. The WTRU 210 may decide to release the PDU session in a case where the WTRU 210 only intended to use the PDU session for traffic associated with one or more non-3GPP devices and to provide QoS differentiation for the traffic of the non-3GPP devices.

In one embodiment, reception of the PDU session modification reject message with the cause code #99 may NOT trigger the WTRU 210 to send a PDU session release request to release the PDU session. The WTRU 210 may decide to NOT release the PDU session in case the WTRU 210 also uses the PDU session for traffic that dis not associated with one or more non-3GPP devices and/or also uses the PDU session for traffic from non-3GPP devices that does not require QoS differentiation.

In some embodiments, the 5GSM cause code that is included in the PDU session modification reject message may be a new 5GSM cause code that is used to specifically indicate that the SMF does not support QoS differentiation for the traffic of non-3GPP devices.

In step 6, the WTRU 210 checks if it has one or more available DNN and S-NSSAI combination information stored in a DNN/S-NSSAI list configured for QoS differentiation of the traffic for non-3GPP devices connecting via the WTRU. The WTRU 210 selects a different DNN and S-NSSAI combination from the one which was tried before in step 2. For example, the UE picks DNN/S-NSSAI-2 from the list and DNN/S-NSSAI-2 is different from DNN/S-NSSAI-1. The WTRU 210 is triggered to pick a different DNN/S-NSSAI combination than the DNN/S-NSSAI combination that is associated with the PDU session that was rejected in step 5. The WTRU 210 is triggered to select a new DNN/S-NSSAI combination because the WTRU 210 needs to establish a PDU session that can be used to provide QoS differentiation for traffic that is associated with non-3GPP devices.

In step 7, the WTRU 210 successfully establishes the PDU session with the core network using the selected DNN/S-NSSAI-2 combination from step 6. The AMF 220 selects SMF-2 240 during the PDU session establishment procedure. Again, the AMF 220 is not aware that the WTRU 210 has the intention to use the QoS differentiation feature or that the selected SMF (i.e., SMF-2 240) supports this feature.

In step 8, one or more non-3GPP devices (not shown) connected to the WTRU 210 requires QoS differentiation. Alternatively, the one or more non-3GPP devices may have connected to the WTRU 210 in step 3.

In step 9, the WTRU 210 triggers a PDU session modification procedure to enable the QoS differentiation of traffic from the connected non-3GPP device(s). The WTRU 210 sends a PDU session modification request message to SMF-2 240 via the AMF 220. The PDU session modification request message may include non-3GPP device identifier(s) and user plane address information.

In a first scenario, described with reference to steps 10 and 11 in FIG. 2, the selected SMF-2 240 does not support the QoS differentiation of traffic from the connected non-3GPP device(s).

In step 10, since SMF-2 240 does not support the QoS differentiation of traffic for non-3GPP devices connecting via a WTRU, SMF-2 240 rejects the PDU session modification request and sends in response a PDU session modification reject message to the WTRU 210. The PDU session modification reject message includes a cause code #99 indicating information element non-existent or not implemented. Reception of the PDU session modification reject message with the #99 cause code may trigger the WTRU 210 to send a PDU session release request to release the PDU session. The WTRU 210 may decide to release the PDU session because the WTRU 210 only intended to use the PDU session for traffic from non-3GPP devices and to provide QoS differentiation for the traffic of the non-3GPP devices.

Note that, in one embodiment, the 5GSM cause code that is included in the PDU session modification reject message may be a new 5GSM cause code that is used to specifically indicate that the SMF-2 240 does not support QoS differentiation for the traffic of non-3GPP devices.

In step 11, if there are available DNN and S-NSSAI combinations in the stored DNN/S-NSSAI list, the WTRU 210 may repeat steps 6 to 9 for each DNN and S-NSSAI combination. This repetition is an attempt to establish a PDU session via an SMF that does not reject the PDU session modification message when the WTRU 210 requests support for QoS differentiation of traffic from non-3GPP devices. In other words, in an attempt to establish a PDU session that does support the QoS differentiation feature.

In case there are no more available DNN and S-NSSAI combinations available in the stored DNN/S-NSSAI list, the WTRU may take the following actions. In one embodiment, the WTRU 210 indicates to the user of WTRU 210 (for example, via GUI/man machine interface (MMI)) that QoS differentiation of traffic from a non-3GPP device is not available. In one embodiment, the WTRU 210 uses the established, unmodified PDU session (i.e., the PDU session established with the SMF-2 240 in step 7) to send traffic from the non-3GPP device(s). In this case, the traffic will likely be associated with the default QoS flow of the PDU session. In other words, the WTRU 210 will transmit the traffic from a non-3GPP device without the traffic receiving QoS differentiation that considers information about the non-3GPP device's traffic that is stored in the UDR.

In another embodiment, the WTRU 210 does not further attempt to modify the PDU session by sending non-3GPP device identifiers in a PDU session modification message for the PDU session. In other words, the WTRU 210 stops attempting to configure the PDU session to provide QoS differentiation for non-3GPP devices. In other words, the WTRU 210 does not attempt to send another PDU session modification request that includes a non-3GPP device identifier for the PDU session for the DNN and S-NSSAI combination until the PDU session is released.

In some embodiments, the WTRU 210 may be configured via a GUI or other means (local configuration, configuration provided by the home operator, application function, third party, etc.) to not allow traffic if it is associated with a non-3GPP device identifier connecting via the WTRU if the PDU session does not support QoS differentiation for a non-3GPP device(s). Thus, when so configured, the WTRU 210 may discard, drop, or block any traffic that is received from a non-3GPP device whose traffic requires QoS differentiation when a PDU session cannot provide QoS differentiation. When the WTRU 210 is not able to activate QoS differentiation for non-3GPP devices, whether the WTRU 210 allows any non-3GPP device traffic to be sent in the default QoS flow or whether WTRU 210 UE blocks, discards or drops the traffic, may be based on user configuration that is input to the WTRU 210 via a GUI (or other input device(s)).

In a second scenario, described with reference to steps 12 and 13 in FIG. 2, the selected SMF-2 240 DOES support the QoS differentiation of traffic from the connected non-3GPP device(s).

In step 12, the selected SMF-2 240 does support the QoS differentiation of traffic from non-3GPP devices connecting via the WTRU. The WTRU 210 is able to trigger the successful Network-requested PDU session modification procedure as is known (see for example, 3GPP TS 24.501, subclause 6.3.2). A PDU session modification accept message may be received by WTRU 210.

In step 13, the 5G System is able to successfully provide the QoS differentiation of traffic from non- 3GPP devices connecting via the WTRU.

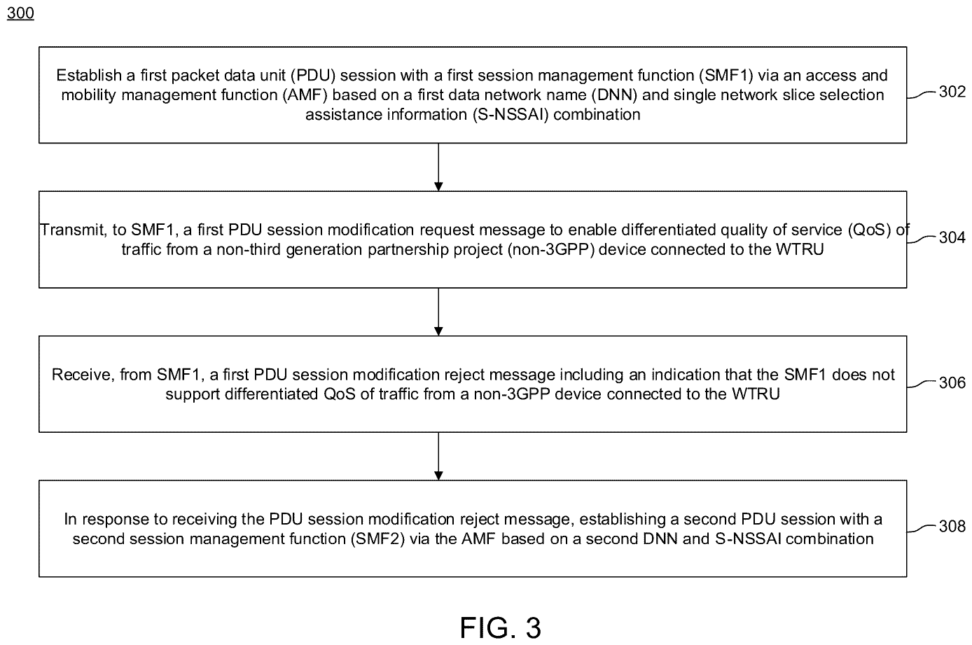

Referring to FIG. 3, a method flow diagram of a method 300 performed by a WTRU is shown. At 310, the WTRU establishes a first packet data unit (PDU) session with a first session management function (SMF1) via an access and mobility management function (AMF) based on a first data network name (DNN) and single network slice selection assistance information (S-NSSAI) combination. At step 320, the WTRU transmits, to SMF1, a first PDU session modification request message to enable differentiated quality of service (QoS) of traffic from a non-third generation partnership project (non-3GPP) device connected to the WTRU. At step 330, the WTRU receives, from SMF 1, a first PDU session modification reject message including an indication that the SMF1 does not support differentiated QoS of traffic from a non-3GPP device connected to the WTRU. At step 340, the WTRU, in response to receiving the PDU session modification reject message, establishes a second PDU session with a second session management function (SMF2) via the AMF based on a second DNN and S-NSSAI combination.

In some embodiments of procedures described above, the WTRU may be in a roaming scenario. In such a case, an PDU session modification reject could come from the V-SMF based on the V-SMF not supporting the QoS differentiation feature or come from the V-SMF based on a cause that is received from the H-SMF. The V-SMF in the roaming case could be analogous to the SMF-1 and/or SMF-2 described above with reference to FIG. 2.

The V-SMF may be configured with information that indicates whether the H-SMF supports the QoS differentiation for non-3GPP devices feature. Thus, the V-SMF may send, to the WTRU, a rejection cause code that indicates that the QoS differentiation for non-3GPP devices feature is not supported.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use by a wireless transmit/receive unit (WTRU), the method comprising:
establishing a first packet data unit (PDU) session with a first session management function (SMF1) via an access and mobility management function (AMF) based on a first data network name (DNN) and single network slice selection assistance information (S-NSSAI) combination;
transmitting, to SMF1, a first PDU session modification request message to enable differentiated quality of service (QoS) of traffic from a non-third generation partnership project (non-3GPP) device connected to the WTRU;
receiving, from SMF1, a first PDU session modification reject message including an indication that the SMF1 does not support differentiated QoS of traffic from a non-3GPP device connected to the WTRU; and
in response to receiving the PDU session modification reject message, establishing a second PDU session with a second session management function (SMF2) via the AMF based on a second DNN and S-NSSAI combination.

2. The method of claim 1, further comprising:
transmitting, to SMF2, a second PDU session modification request message to enable differentiated QoS of traffic from a non-3GPP device connected to the WTRU;
receiving, from SMF2, a second PDU session modification reject message including an indication that the SMF2 does not support differentiated QoS of traffic from a non-3GPP device connected to the WTRU.

3. The method of claim 1, further comprising:
establishing a connection with a non-3GPP device; and
receiving non-3GPP device traffic that requires uplink transmission via a PDU session.

4. The method of claim 2, further comprising:
notifying a user of the WTRU that differentiated QoS of traffic from a non-3GPP device is not supported; and
using the second PDU session established with the SMF2 for traffic from a non-3GPP device connected to the WTRU.

5. The method of claim 2, further comprising:
notifying a user of the WTRU that differentiated QoS of traffic from a non-3GPP device is not supported; and
blocking traffic from a non-3GPP device connected to the WTRU.

6. The method of claim 1, further comprising:
transmitting, to SMF2, a second PDU session modification request message to enable differentiated QoS of traffic from a non-3GPP device connected to the WTRU; and
receiving, from SM2, a PDU session modification accept message enabling differentiated QoS of traffic from a non-3GPP device connected to the WTRU; and
using the second PDU session with SMF2 to communicate traffic from a non-3GPP device connected to the WTRU.

7. The method of claim 1, wherein the PDU session modification reject message includes a 5G session management (5GSM) cause code #99.

8. The method of claim 1, wherein the WTRU stores a list including a plurality of DNN entries and a plurality of S-NSSAI entries.

9. The method of claim 1, further comprising:
releasing the first PDU session upon receiving the first PDU session modification reject message.

10. The method of claim 1, wherein the first PDU session modification request message includes a non-third generation partnership project (non-3GPP) device identifier and a user plane address of a non-3GPP device.

11. A wireless transmit/receive unit (WTRU) comprising:
at least one processor; and
a transceiver coupled to the at least one processor, the at least one processor and transceiver configured to:
establish a first packet data unit (PDU) session with a first session management function (SMF1) via an access and mobility management function (AMF) based on a first data network name (DNN) and single network slice selection assistance information (S-NSSAI) combination;
transmit, to SMF1, a first PDU session modification request message to enable differentiated quality of service (QoS) of traffic from a non-third generation partnership project (non-3GPP) device connected to the WTRU;
receive, from SMF1, a first PDU session modification reject message including an indication that the SMF1 does not support differentiated QoS of traffic from a non-3GPP device connected to the WTRU; and
in response to receiving the PDU session modification reject message, establish a second PDU session with a second session management function (SMF2) via the AMF based on a second DNN and S-NSSAI combination.

12. The WTRU of claim 11, wherein the at least one processor and transceiver configured to:
transmit, to SMF2, a second PDU session modification request message to enable differentiated QoS of traffic from a non-3GPP device connected to the WTRU;
receive, from SMF2, a second PDU session modification reject message including an indication that the SMF2 does not support differentiated QoS of traffic from a non-3GPP device connected to the WTRU.

13. The WTRU of claim 11, wherein the at least one processor and transceiver configured to:
establish a connection with a non-3GPP device; and
receive non-3GPP device traffic that requires uplink transmission via a PDU session.

14. The WTRU of claim 12, wherein the at least one processor and transceiver configured to:
notify a user of the WTRU that differentiated QoS of traffic from a non-3GPP device is not supported; and
use the second PDU session established with the SMF2 for traffic from a non-3GPP device connected to the WTRU.

15. The WTRU of claim 12, wherein the at least one processor and transceiver configured to:
notify to a user of the WTRU that differentiated QoS of traffic from a non-3GPP device is not supported; and
block traffic from a non-3GPP device connected to the WTRU.

16. The WTRU of claim 11, wherein the at least one processor and transceiver configured to:
transmit, to SMF2, a second PDU session modification request message to enable differentiated QoS of traffic from a non-3GPP device connected to the WTRU; and
receive, from SM2, a PDU session modification accept message enabling differentiated QoS of traffic from a non-3GPP device connected to the WTRU; and
use the second PDU session with SMF2 to communicate traffic from a non-3GPP device connected to the WTRU.

17. The WTRU of claim 11, wherein the PDU session modification reject message includes a 5G session management (5GSM) cause code #99.

18. The WTRU of claim 11, wherein the WTRU further comprises a memory configured to store a plurality of DNN entries and a plurality of S-NSSAI entries.

19. The WTRU of claim 11, wherein the at least one processor and transceiver configured to:
release the first PDU session upon receiving the first PDU session modification reject message.

20. The WTRU of claim 11, wherein the first PDU session modification request message includes a non-third generation partnership project (non-3GPP) device identifier and a user plane address of a non-3GPP device.
